(19) United States
(12) Patent Application Publication
(10) Pub. No.: US 2011/0088855 A1
(43) Pub. Date: Apr. 21, 2011

(54) VEHICLE SUNSHADE DEVICE

(76) Inventor: MHD YASER BOUSTANI, Taipei City (TW)

(21) Appl. No.: 12/580,277

(22) Filed: Oct. 16, 2009

(51) Int. Cl. B60J 1/20

(52) U.S. Cl. 160/370.22

(57) ABSTRACT

A vehicle sunshade device for shading a vehicle from sunshine and rain is provided. The vehicle sunshade device includes a casing, two reels, a base, a plurality of connecting rods, and two side panels. The connecting rods are pivotally coupled to the casing inwardly and are extendable out of the casing in opposite outward directions to thereby drive a sunblind wound around each of the two reels and extend the sunblinds outward for shading the vehicle from sunshine and rain.

### BACKGROUND OF THE INVENTION

1. Technical Field

The present invention relates to vehicle sunshade devices and, more particularly, to a movable, retractable vehicle sunshade device.

2. Description of Related Art

In the heat of summer sunshine, it is important to prevent an excessive increase in temperature inside vehicles parked outdoors and exposed to the scorching sunshine. To this end, drivers usually put sunblinds or window films on windshields and windows of their vehicles to prevent sunlight from penetrating the windshields and windows. Sunblinds for use with vehicles come in different forms and are attached to glass mostly by suckers. However, it is not uncommon for a sunblind to detach under its own weight or due to inadequate suction. On the other hand, although window films adhere to windshields and windows tightly, window films have the following disadvantages. First, window films are usually opaque or dark-colored so as to be effective in blocking sunlight, but at the cost of driver visibility. Moreover, application of sunblinds and window films is limited to windshields and windows, thus leaving vehicular bodies uncovered, and in consequence intravehicular temperature will still rise when the vehicular bodies are exposed to the sunshine.

### BRIEF SUMMARY OF THE INVENTION

A primary objective of the present invention is to provide a vehicle sunshade device essentially comprising a casing, two reels, a base, a plurality of connecting rods, and two side panels, wherein the vehicle sunshade device is configured to rest on top of a vehicle by means of the base, and the plurality of connecting rods pivotally coupled to the casing inwardly are extendable out of the casing to thereby drive sunblinds wound around the two reels and extend the sunblinds outward with a view to protecting the vehicle against sunshine and rain.

Another objective of the present invention is to provide a vehicle sunshade device comprising a pivot for coupling the casing and the base together and thereby enabling vertical displacement (by changing the altitude of use) and rotation (by changing the orientation) of the casing as needed so as for the sunblinds extended outward to shade whatever portions of the body of the vehicle as needed.

### BRIEF DESCRIPTION OF THE SEVERAL VIEWS OF THE DRAWINGS

FIG. 1 is a perspective view of the present invention;

FIG. 2 is an exploded perspective view of the present invention;

FIG. 3 is a perspective view of a preferred embodiment of the present invention;

FIG. 4 is another perspective view of the preferred embodiment of the present invention;

FIG. 5 is yet another perspective view of the preferred embodiment of the present invention;

FIG. 6 is a further perspective view of the preferred embodiment of the present invention;

FIG. 7 is a further perspective view of the preferred embodiment of the present invention;

FIG. 8 is a perspective view of another preferred embodiment of the present invention;

FIG. 9 is another perspective view of the another preferred embodiment of the present invention;

FIG. 10 is a perspective view of yet another preferred embodiment of the present invention; and

FIG. 11 is another perspective view of the yet another preferred embodiment of the present invention.

### DETAILED DESCRIPTION OF THE INVENTION

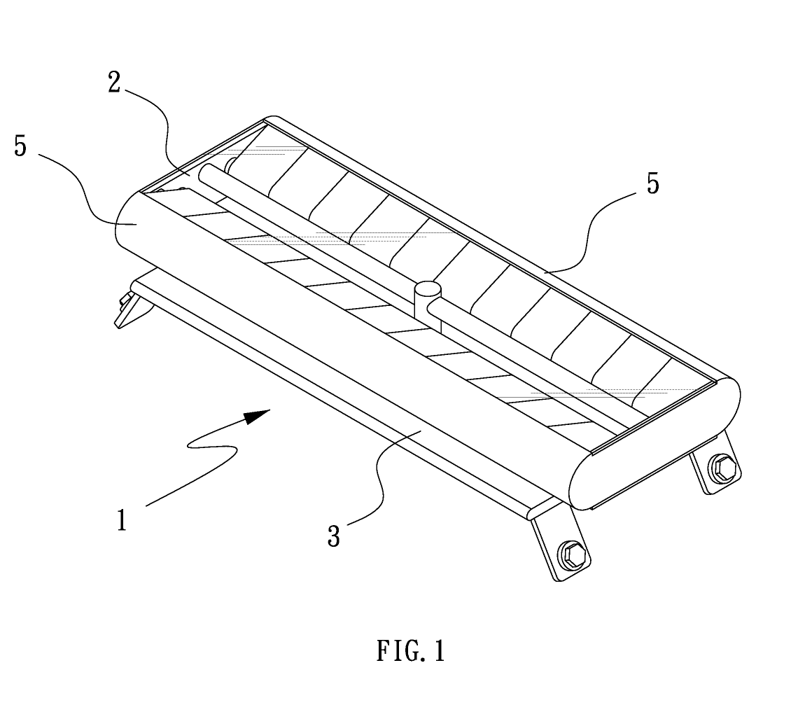

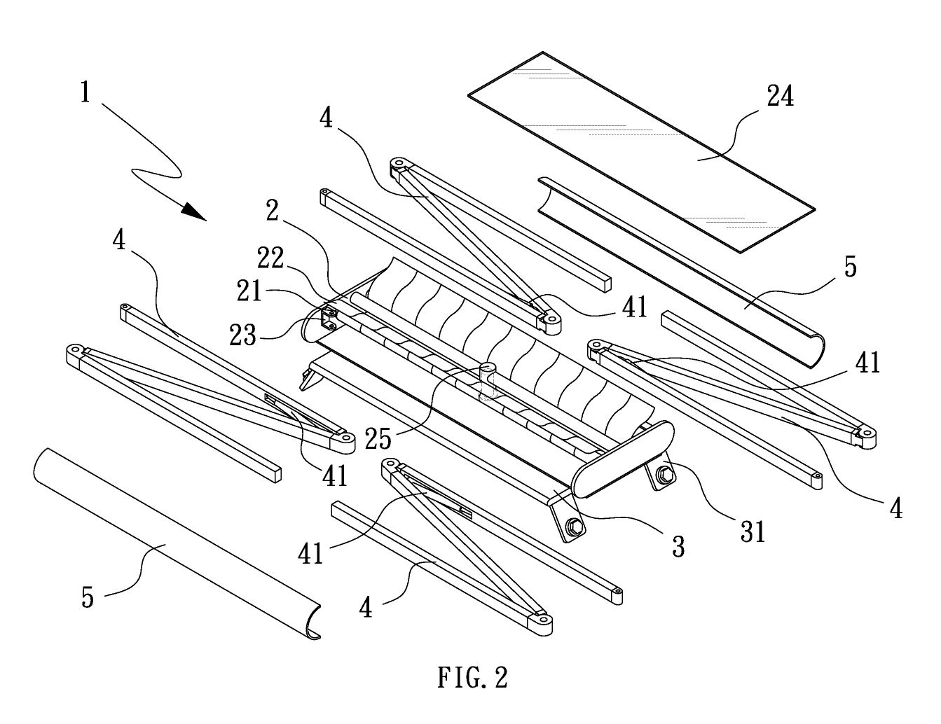

Referring to FIG. 1 and FIG. 2 for a perspective view and an exploded perspective view of the present invention, a vehicle sunshade device 1 essentially comprises a casing 2, two reels 21, a base 3, a plurality of connecting rods 4, and two side panels 5.

The casing 2 is provided thereabove with a transparent cover 24 for covering and protecting a plurality of objects accommodated in the casing 2.

The two reels 21 are disposed in the casing 2. Two sunblinds 22 made of a flexible soft material are wound around the two reels 21, respectively.

The base 3 is coupled to the casing 2 from below by means of a pivot 25. A plurality of fastening elements 31 are provided laterally on the base 3.

The plurality of connecting rods 4 are pivotally coupled, by means of pivotally connecting elements 23, to the casing 2 inwardly and in pairs. Each of the connecting rods 4 is provided with a compression rod 41. The compression rod 41 is a pneumatic compression rod or a hydraulic compression rod.

The two side panels 5 are coupled to outer ends of the connecting rods 4 and outer ends of the sunblinds 22 wound around the two reels 21, respectively.

The vehicle sunshade device 1 is configured to rest on top of a vehicle. The plurality of connecting rods 4 pivotally coupled to the casing 2 inwardly are extendable out of the casing 2 to thereby drive the sunblinds 22 wound around the two reels 21 and extend the sunblinds 22 outward, thus allowing the sunblinds 22 to shade the body of the vehicle.

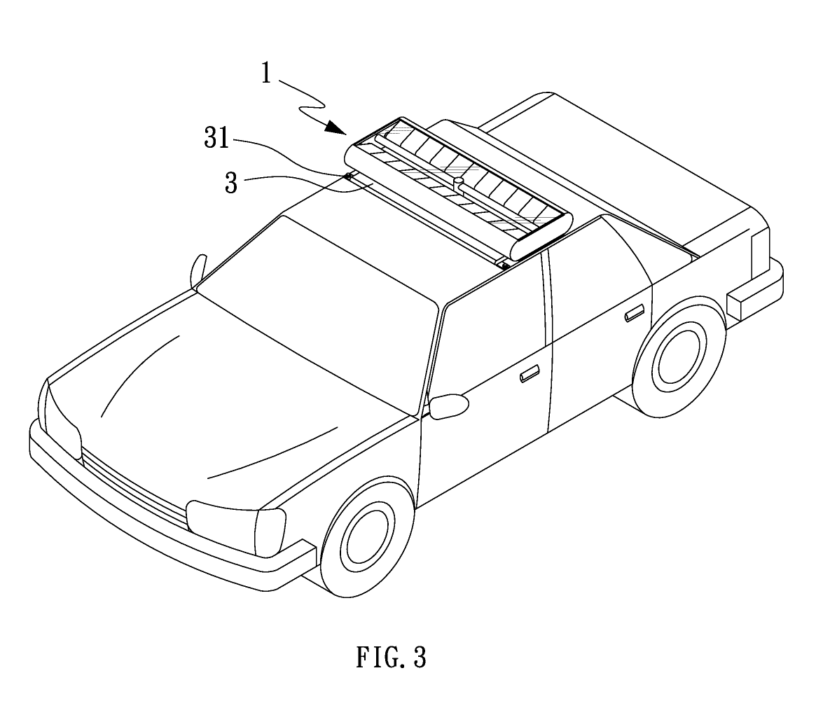

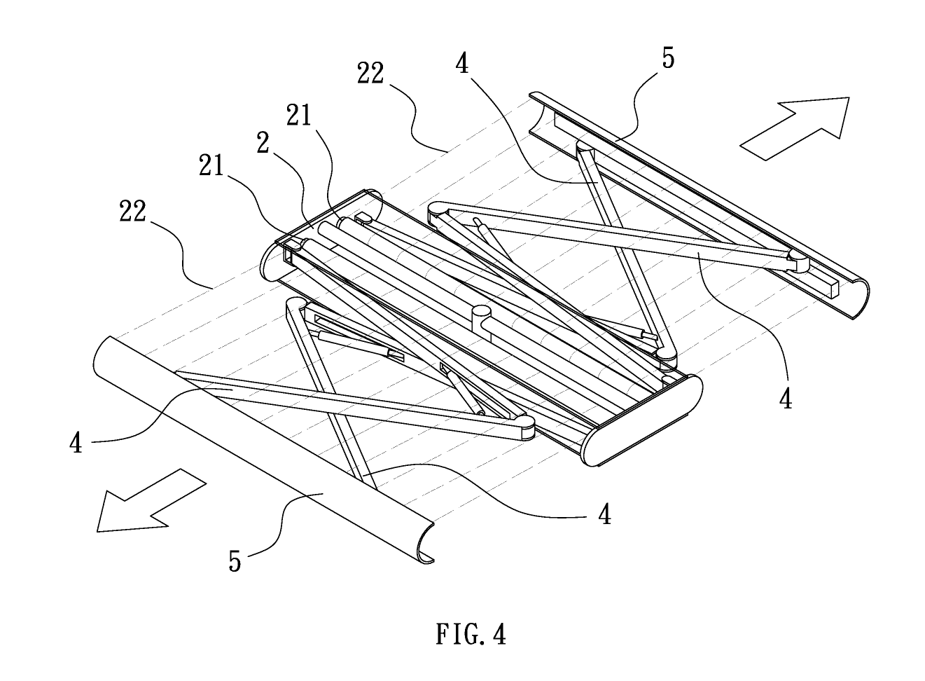

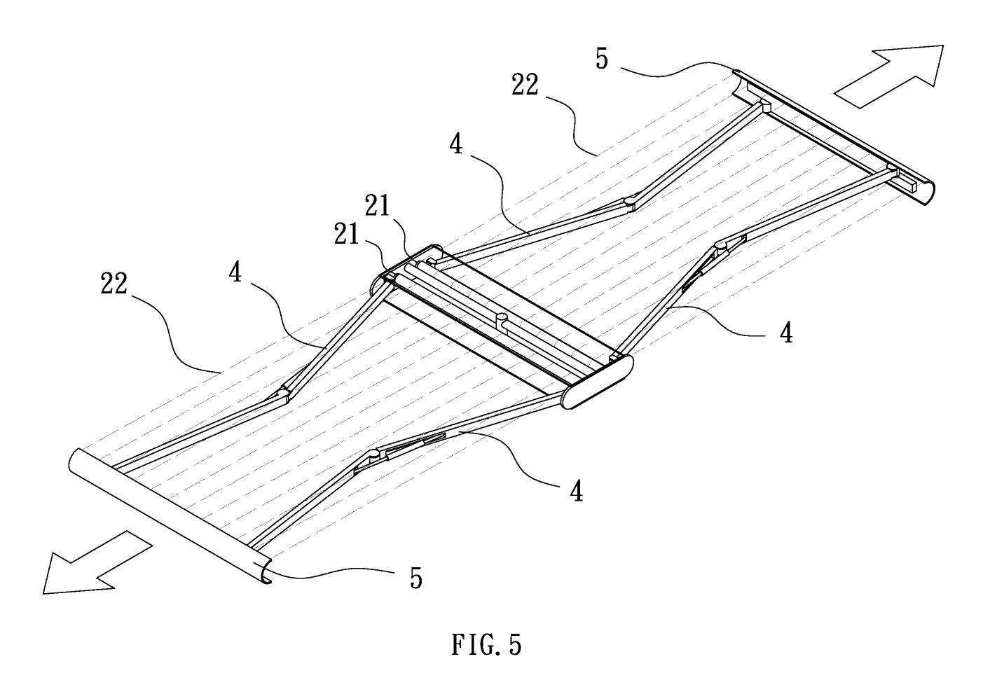

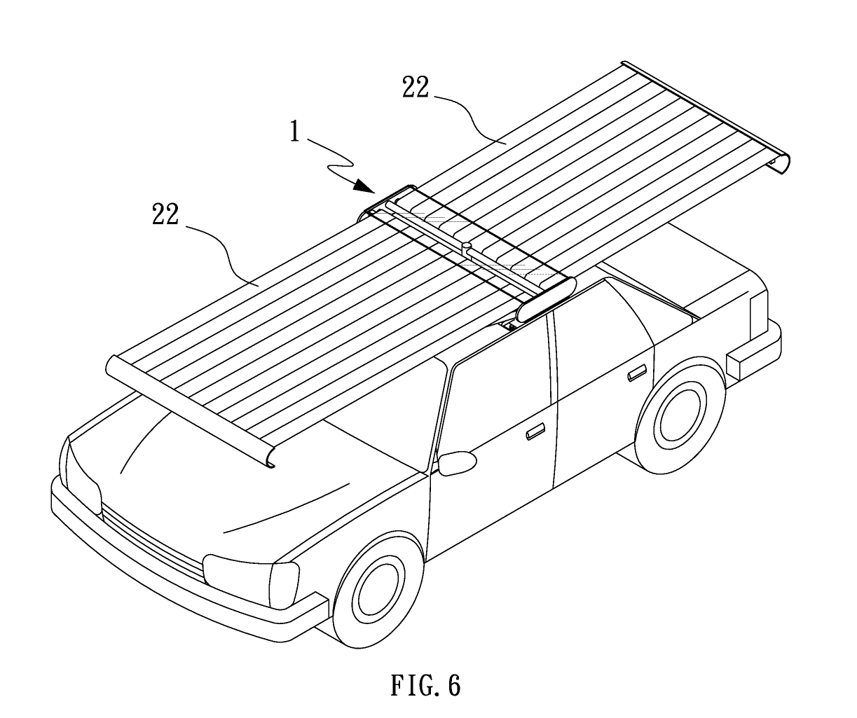

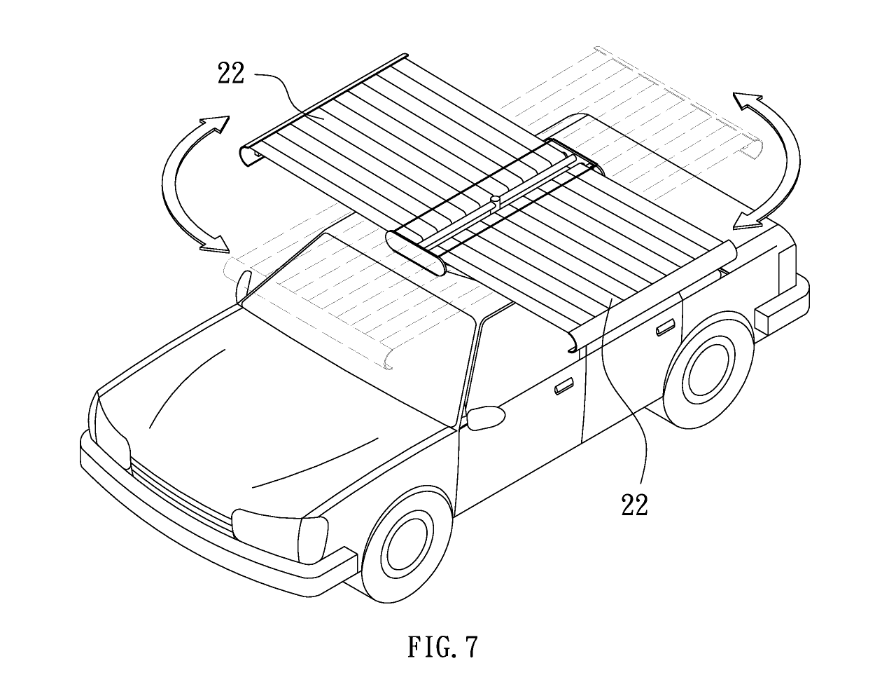

In addition to FIG. 2, please refer to FIGS. 3, 4, 5, 6, and 7 for perspective views of a preferred embodiment of the present invention. As shown in the drawings, the vehicle sunshade device 1 is fixed in position to the top of the vehicle by means of the plurality of fastening elements 31 provided laterally on the base 3. After parking the vehicle outdoors, the driver of the vehicle extends, in opposite outward directions, four said connecting rods 4 pivotally coupled to the casing 2 inwardly. In so doing, the driver extends, in opposite outward directions, the sunblinds 22 wound around the two reels 21. Hence, the extended sunblinds 22 can shade the body of the vehicle. The driver can adjust the extension of the connecting rods 4 according to the intended extent of shade of the sunblinds 22. Each of the four connecting rods 4 is provided with the compression rod 41 for facilitating movement of the connecting rods 4 during extension/retraction thereof. The pivot 25 provided between the casing 2 and the base 3 enables vertical displacement and rotation of the casing 2. More specifically, the pivot 25 not only enables the casing 2 to be elevated to an intended level but also enables the casing 2 to be rotated to an intended orientation as needed. Hence, by virtue of the pivot 25, the extended sunblinds 22 can be adjusted so as to shade an intended portion of the body of the vehicle and thereby protect the vehicle against sunshine and rain.

To retract the vehicle sunshade device 1, the driver tucks the extended connecting rods 4 into the casing 2, winds the sunblinds 22 around the reels 21, and, after the plurality of connecting rods 4 and the sunblinds 22 are fully received in the casing 2, covers two lateral sides of the casing 2 with the two side panels 5 which are coupled to the outer ends of the connecting rods 4. Hence, the two side panels 5 flanking the casing 2 and the transparent cover 24 provided above the casing 2 together protect the various objects accommodated in the casing 2 and prevent dust and foreign bodies from intruding into the casing 2 when the vehicle sunshade device 1 is not in use.

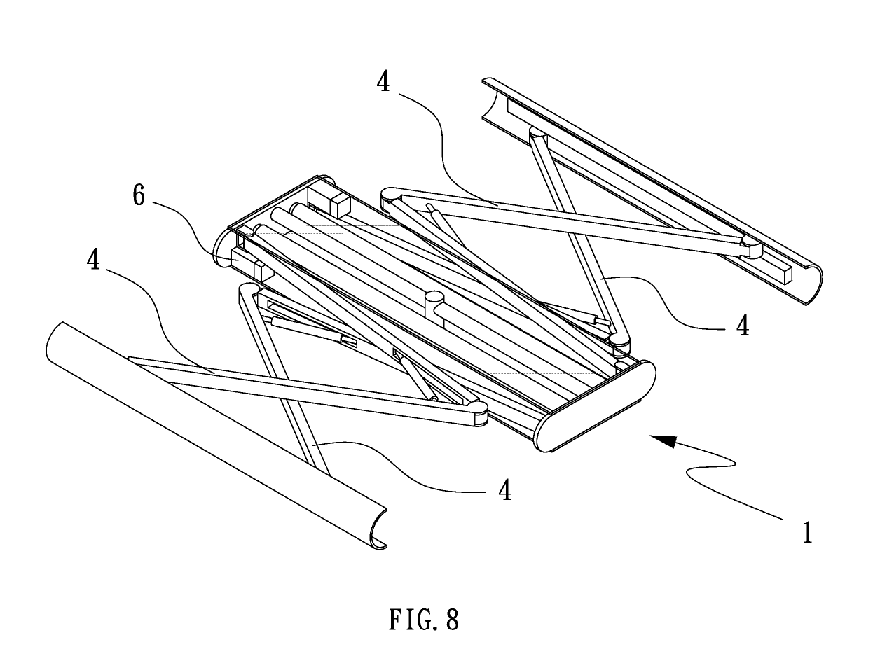

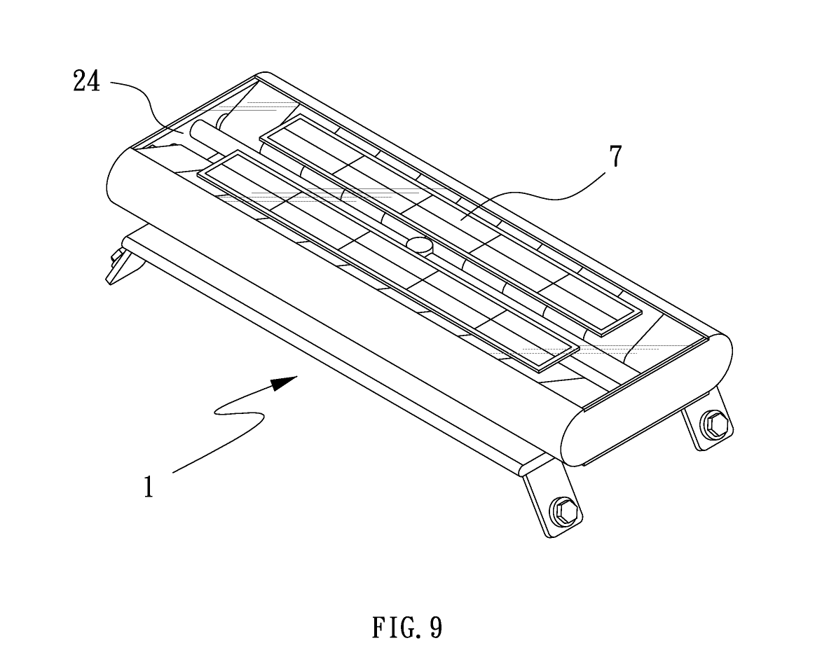

Please refer to FIGS. 8 and 9 for perspective views of another preferred embodiment of the present invention. As shown in the drawings, the vehicle sunshade device 1 is installed therein with at least a power device 6, such as a motor, and four said connecting rods 4 are extendable outward when powered by the power device 6. Also, the transparent cover 24 is provided thereon with a solar panel 7 whereby the vehicle sunshade device 1 converts solar energy into electrical energy when irradiated by sunlight, thus supplying electric power to the power device 6 or any other devices in the vehicle.

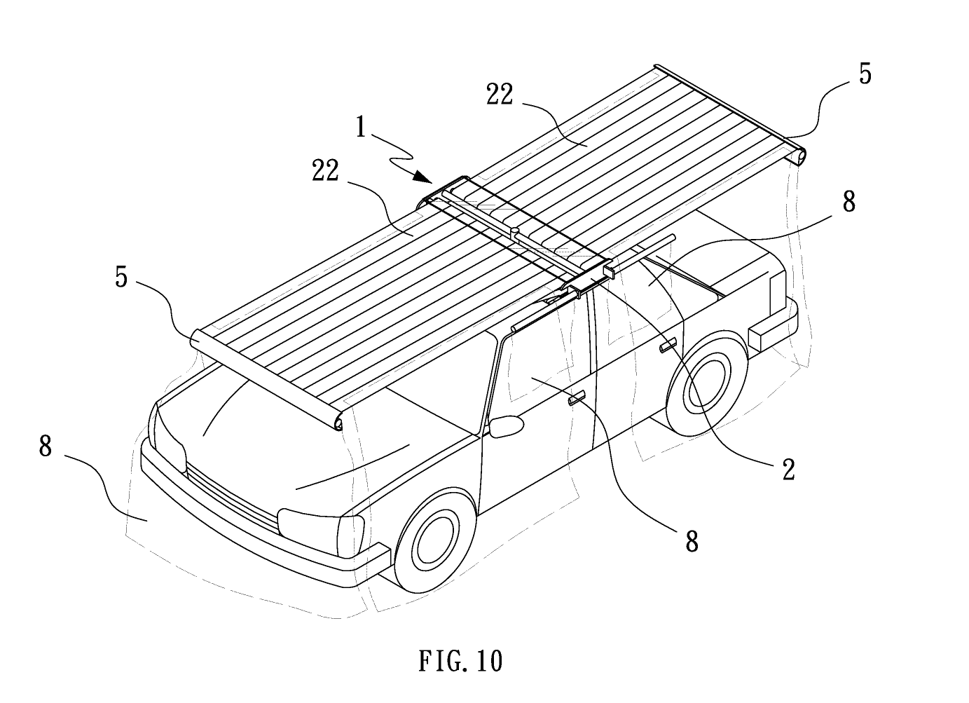

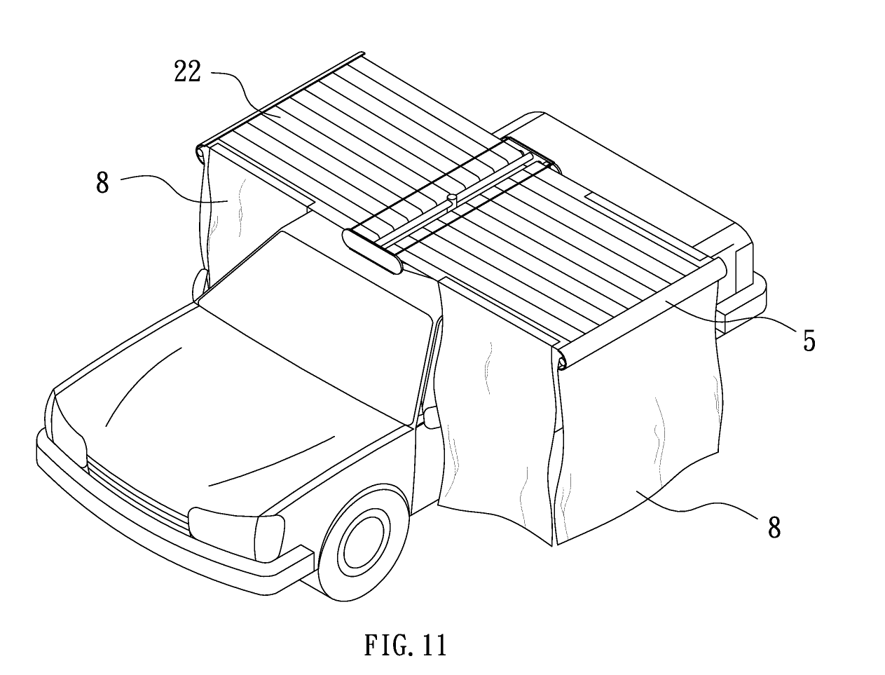

Please refer to FIGS. 10 and 11 for perspective views of yet another preferred embodiment of the present invention. As shown in the drawings, after the sunblinds 22 of the vehicle sunshade device 1 are extended outward, a plurality of blinds 8 can be attached to the casing 2, the sunblinds 22, and the side panels 5 by buttons, Velcro, zippers, or reels such that the blinds 8 jointly function as a tent for use in camping or barbecues or provide additional shade for the vehicle.

What is claimed is:

1. A vehicle sunshade device, configured to rest on top of a vehicle, essentially comprising:
a casing;
a plurality of reels disposed in the casing, wherein a sunblind is wound around each of the reels;
a base coupled to the casing from below;
a plurality of connecting rods pivotally coupled to the casing inwardly and in pairs; and
two side panels coupled to outer ends of the connecting rods, respectively;
wherein the plurality of connecting rods pivotally coupled to the casing inwardly are extendable out of the casing to thereby drive the sunblind wound around each of the reels and extend the sunblinds outward, so as for the extended sunblinds to shade the vehicle from sunshine and rain.

2. The vehicle sunshade device of claim 1, wherein the casing is provided thereabove with a transparent cover.

3. The vehicle sunshade device of claim 1, wherein the base and the casing are provided therebetween with a pivot for enabling rotation and vertical displacement of the casing.

4. The vehicle sunshade device of claim 1, wherein the sunblinds are made of a flexible soft material.

5. The vehicle sunshade device of claim 1, wherein the two side panels are coupled to outer ends of the sunblinds wound around the plurality of reels, respectively.

6. The vehicle sunshade device of claim 1, wherein each of four said connecting rods is pivotally coupled to the casing inwardly by a pivotally connecting element.

7. The vehicle sunshade device of claim 1, wherein a plurality of fastening elements are provided laterally on the base.

8. The vehicle sunshade device of claim 1, wherein the connecting rods are each provided with a compression rod.

9. The vehicle sunshade device of claim 8, wherein the compression rods are pneumatic compression rods or hydraulic compression rods.

10. The vehicle sunshade device of claim 1, wherein the casing is provided therein with at least a power device such that the connecting rods are extendable when powered by the power device.

11. The vehicle sunshade device of claim 2, wherein the transparent cover is provided thereon with a solar panel.
